(19) United States
(12) Patent Application Publication
(10) Pub. No.: US 2022/0007627 A1
(43) Pub. Date: Jan. 13, 2022

(54) Line Spool Clamping Device and Fishing Reel Winding Device

(71) Applicant: Shandong Huaqing Technology Co., Ltd, Ji'nan (CN)

(72) Inventor: Pan Zhenguo, Beijing (CN)

(21) Appl. No.: 16/923,149

(22) Filed: Jul. 8, 2020

(51) Int. Cl. A01K 89/01

(52) U.S. Cl. CPC A01K 89/01083; A01K 89/027; A01K 89/0111

(57) ABSTRACT

A line spool clamping device and fishing reel winding device, said line spool clamping device comprises a left line spool clamping arm and a right line spool clamping arm, the lower part of said left line spool clamping arm is provided with a left hinging seat, and the lower part of said right line spool clamping arm is provided with a right hinging seat, a left clamping slide sleeve is provided in said left hinging seat, a right clamping slide sleeve is provided in said right hinging seat, left coupling shaft is provided in said left clamping slide sleeve, right coupling shaft is provided in said right clamping slide sleeve, the left end of said right coupling shaft is provided with a right conical clamping head, the right end of said left coupling shaft is provided with a left conical clamping head.

### TECHNICAL FIELD

This invention relates to the fishing tackle field, particularly to a line spool clamping device and fishing reel winding device with both the winding and rewinding functions and characterized by a simple structure, convenience in use, durability, long service life, stability in use and low noise.

### BACKGROUND OF THE INVENTION

To facilitate fishing wire winding on the fishing reel, technicians have developed the fishing reel winding device. There are a variety of structures of fishing reel winding devices which all comprise the line spool clamping device used for installing the line spool and the connecting base used for connecting to the fishing rod. The line spool clamping device comprises a left line spool clamping arm and a right line spool clamping arm which are used for clamping and locating the line spool. The connecting base and the line spool clamping arm are directly connected and fixed or are connected and fixed via a supporting arm. In service, the left line spool clamping arm and the right line spool clamping arm clamp on both sides of the central hole of the line spool to connect the rotatable line spool connect to the line spool clamping device. A connecting base is used to connect and fix the line spool clamping device and the fishing rod. And then one end of the fishing wire on the line spool connects to the fishing reel on the fishing rod. The fishing reel is rotated to drive the line spool to rotate on the line spool clamping device to wind the fishing wire on the fishing reel. One currently salable line spool clamping device comprises a rotating shaft, a supporting arm, two line spool locking arms (left line spool clamping arm and right line spool clamping arm), power arm, locknut and lock disc. The freely rotatable supporting arm can be provided on the rotating shaft, two line spool locking arms are respectively provided on both ends of the supporting arm in the way of hinge, the front end of two line spool locking arms are respectively provided with two opposite line spool clamping heads in the shape of half-sphere, the rear end on the rear side of the hinged shaft of two line spool locking arms is provided with opposite (included angle of 60-100° with the line spool locking arm) power arms, the rotating shaft in front of the power arm is provided with a locknut in the way of thread connection, and the locknut is provided with a lock disc which can press on the front side of the power arm. As regards the aforesaid line spool clamping device, its line spool clamping head is fixed onto the line spool locking arm, the contact part between the central hole of the line spool and the line spool clamping head is in a linear shape in use, so the line spool and the line spool clamping head will be worn severely and loud noise is generated; when different specifications of line spools are used, the line spool clamping head cannot be automatically positioned on the central axis of the line spool and should be adjusted repeatedly, which is troublesome, and especially the stability of the line spool will be poor and the wire will be likely to shake if the line spool clamping head is worn after long time of use; it is of unitary function and cannot realize rewinding of fishing wire. Existing fishing reel winding devices can only be used together with the fishing rod, are subject to the service environment and cannot realize separate wire winding of different fishing reels.

### BRIEF SUMMARY OF INVENTION

The goal of this invention is to solve the defects of existing technologies and provide a line spool clamping device characterized by a simple structure, convenience in use, durability, long service life, stability in use and low noise.

In another aspect, the goal of this invention is to provide a line spool clamping device with both winding and rewinding functions.

In yet another aspect, the goal of this invention is to provide a fishing reel winding device which is characterized by a simple structure and convenience in use and can realize separate wire winding for different fishing reels.

### The Technical Solution of this Invention to the Aforesaid Existing Technical Problems is

A line spool clamping device, comprising a left line spool clamping arm and a right line spool clamping arm, characterized in that the lower part of the left line spool clamping arm is provided with a U-shaped left hinging seat, the lower part of the right line spool clamping arm is provided with a U-shaped right hinging seat, a left clamping slide sleeve is provided in the left hinging seat, a right clamping slide sleeve is provided in the right hinging seat, a left coupling shaft which can rotate freely is provided in the left clamping slide sleeve, a right coupling shaft which can rotate freely is provided in the right clamping slide sleeve, the left end of the right coupling shaft on the left side of the right clamping slide sleeve is provided with a right conical clamping head which fits to the central hole of the line spool, the right end of the left coupling shaft on the right side of the left clamping slide sleeve is provided with a left conical clamping head which fits to the central hole of the line spool, the left end face of the left clamping slide sleeve contacts with the right side face of the right conical clamping head, and the right end face of the left clamping slide sleeve contacts with the left side face of the left conical clamping head; the right coupling shaft on the right side of the right clamping slide sleeve is provided with a slide sleeve spacing ring, and the left coupling shaft on the left side of the left clamping slide sleeve is provided with a slide sleeve spacing ring.

A fishing reel winding device, characterized in comprising an expansion rod, an arc-shaped supporting arm and a line spool clamping device, wherein, said expansion rod is provided with a fishing reel connecting base, the front end of said expansion rod connects to the rear end of said arc-shaped supporting arm, and the front end of said arc-shaped supporting arm connects to said line spool clamping device; said line spool clamping device comprises a rotating shaft, a supporting arm, a left line spool clamping arm, right line spool clamping arm, power arm, locknut and lock disc, the middle of said supporting arm connects to said rotating shaft, left line spool clamping arm and right line spool clamping arm respectively connect to one end of said supporting arm in the way of hinging, the hinged shaft connecting said left line spool clamping arm and said supporting arm and the hinged shaft connecting said right line spool clamping arm and supporting arm are respectively provided with an opposite power arm which forms an included angle of 60-100° with said left line spool clamping arm and said right line spool clamping arm respectively, the rotating shaft on the lower part of said power arm connects to a locknut in the way of thread connection, said locknut is provided with a lock disc which can press on the lower part of said power arm, by rotating the lock disc to press the power arm, the lower part of said left line spool clamping arm and right line spool clamping arm can be driven to move oppositely to clamp said line spool; The lower part of the left line spool clamping arm is provided with a U-shaped left hinging seat, the lower part of the right line spool clamping arm is provided with a U-shaped right hinging seat, a left clamping slide sleeve is provided in the left hinging seat, a right clamping slide sleeve is provided in the right hinging seat, a left coupling shaft which can rotate freely is provided in the left clamping slide sleeve, a right coupling shaft which can rotate freely is provided in the right clamping slide sleeve, the left end of the right coupling shaft on the left side of the right clamping slide sleeve is provided with a right conical clamping head which fits to the central hole of the line spool, the right end of the left coupling shaft on the right side of the left clamping slide sleeve is provided with a left conical clamping head which fits to the central hole of the line spool, the left end face of the left clamping slide sleeve contacts with the right side face of the right conical clamping head, and the right end face of the left clamping slide sleeve contacts with the left side face of the left conical clamping head; the right coupling shaft on the right side of the right clamping slide sleeve is provided with a slide sleeve spacing ring, and the left coupling shaft on the left side of the left clamping slide sleeve is provided with a slide sleeve spacing ring; the front end of said arc-shaped supporting arm connects to the rotating shaft of said line spool clamping device.

The middle of said left conical clamping head and said left coupling shaft of this invention are provided with a (coaxial) left inserted rod through-hole, and the middle of said right conical clamping head and said right coupling shaft is provided with a (coaxial) right inserted rod through-hole; a rewinding connecting rod which can be inserted in the left inserted rod through-hole and the right inserted rod through-hole at the same time is provided, the right end of the rewinding connecting rod is provided with a rewinding crank, the rewinding connecting rod on the left side of the rewinding crank is provided with a connecting shaft locating bulge loop, the rewinding connecting rod on the left side of the left coupling shaft is provided with a connecting shaft locknut in the way of thread connection.

a smooth wear-resistant gasket is provided with the left end face of said right clamping slide sleeve of this invention and the right side face of said right conical clamping head, and a smooth wear-resistant gasket is provided between the right side face of said left clamping slide sleeve and the left side face of said left conical clamping head. Said smooth wear-resistant gasket can be a smooth metal gasket, graphite gasket, etc.; such a gasket can reduce friction and cannot be worn easily, and its service life can be prolonged.

The structure which is provided with said left clamping slide sleeve and said right clamping slide sleeve of this invention in the way of hinge respectively in said left hinging seat and said right hinging seat is: The lower part of two hinging arms of said left hinging seat are provided with hinging holes respectively, the right side of hinging holes inside two hinging arms is provided with an outward tilted left hinging guide slide slot from the left to the right respectively, both sides of said left clamping slide sleeve are provided with a left hinging column fitted to two hinging holes on said left hinging seat, the left side of two left hinging columns is respectively provided with a guide slide face which is outward tilted from the left to the right and is fitted to two left hinging guide slide slots; The lower part of two hinging arms of said right hinging seat are provided with hinging holes respectively, the left side of hinging holes inside two hinging arms is provided with an outward tilted right hinging guide slide slot from the right to the left respectively, both sides of said right clamping slide sleeve are provided with a right hinging column fitted to two hinging holes on said right hinging seat, the right side of two right hinging columns is respectively provided with a guide slide face which is outward tilted from the right to the left and is fitted to two right hinging guide slide slots. When said left clamping slide sleeve connects to said left hinging seat and when said right clamping slide sleeve connects to right hinging seat, the user only needs to press the guide slide face of said left hinging column and said right hinging column into the two hinging arms of the left hinging seat and the right hinging seat by aligning the guide slide face of said left hinging column and said right hinging column with the fitted left hinging guide slide slot and hinging guide slide slot respectively to open it, two left hinging columns slide into two hinging holes on the left hinging seat, two right hinging columns slide into two hinging holes on the right hinging base, to finish installation of hinged fitting. The hinging structure is simple and can be installed conveniently without using connecting components, such as screw, pin column, etc., reducing costs.

The inner side of two hinging arms of said left hinging seat of this invention as well as the upper side and the lower side of said left hinging guide slide slot on the right side of said hinging holes are respectively provided with a swinging limit block, said left clamping slide sleeve on the right side of said left hinging column is provided with a limit barrier strip fitted to said swinging limit block, said limit barrier strip swings between two swinging limit blocks to limit that said left clamping slide sleeve swings up and down within the scope of a horizontal included angle of 35°; The inner side of two hinging arms of said right hinging seat as well as the upper side and the lower side of said right hinging guide slide slot on the left side of said hinging holes are respectively provided with a swinging limit block, said right clamping slide sleeve on the left side of said right hinging column is provided with a limit barrier strip fitted to said swinging limit block, said limit barrier strip swings between two swinging limit blocks to limit that said right clamping slide sleeve swings up and down within the scope of a horizontal included angle of 35°. During the process when said left conical clamping head and right conical clamping head clamp respectively the left side and the right side of the central hole of the line spool, said left conical clamping head and said right conical clamping head can swing up and down to realize floating-type locating, the centerline of said left conical clamping head and said right conical clamping head coincides with the centerline of the line spool, winding and rewinding will be more stable, when said left conical clamping head and said right conical clamping head do not clamp the central hole of the line spool, their drop angle is small, so that said left conical clamping head and said right conical clamping head align with the central hole of the line spool when the line spool is installed between said left line spool clamping arm and said right line spool clamping arm.

The expansion rod of this invention is a two-section expansion rod comprising a barrel-shaped outer rod and an inner rod, said inner rod can be inserted into said outer rod in the way of axial sliding, said fishing reel connecting base is provided on said outer rod, and said rotating shaft which can rotate freely is installed in the front end of said arc-shaped supporting arm.

The front end of said outer rod of this invention is provided with an expansion locating clip. Said expansion locating clip is used for locking and fixing said inner rod and outer rod as well as adjusting the extruding length of said inner rod according to the fishing reel and as needed by the user. When the fishing tackle is not used, said expansion locating clip can be used for fixing the front end of the retracted inner rod and the outer rod.

The expansion locating clip of this invention comprises a connecting sleeve and a locking hoop, the rear part of the connecting sleeve is fixed on the outer side in the front of the outer rod, the front part of the connecting sleeve is provided on the outer side of said inner rod in the way of radial shrinkage, and the locking hoop is provided on the outer side of said connecting sleeve outside the inner rod. Said connecting sleeve can be made of elastic materials which can shrink radially when bearing load (rubber, plastic, PE) or can be made of non-elastic materials and the side wall of its front part is provided with an axial clamping buffer slot; when said locking hoop is locked, the front part of said connecting sleeve is pressed and fixed on the outer side of said inner rod, said locking hoop is opened, there will be no pressure between the front part of said connecting sleeve and the side wall of said inner rod, and said inner rod can slide front and back freely. Said locking hoop can be a hose clamp, cam locking device, etc.

The said arc-shaped supporting arm of this invention is provided with a locking slide hole parallel to said rotating shaft, a locking pin which can slide freely is provided in said locking slide hole, the front of said locking pin in front of said locking slide hole is provided with a baffle, the locking pin between said baffle and said arc-shaped supporting arm is provided with a locking pressure spring, and the part on said supporting arm and corresponding to said locking slide hole is provided with a locking insertion hole. The rear end of said locking pin on the rear side of said locking slide hole is provided with a locating handle, said locking pin on the front side of said locating handle is provided with an anti-rotation bulge, and said arc-shaped supporting arm is provided with an anti-rotation clamp slot fitted to said anti-rotation bulge. During the process when said line spool is fixed on said line spool clamping device, said locking pin will slide front under the action of said locking pressure spring, the front end of said locking pin is inserted into said locking insertion hole, said anti-rotation bulge on the rear part of said locking pin slides into said anti-rotation clamp slot to lock said supporting arm and prevent rotation of said supporting arm, so that said line spool is installed conveniently. When winding the fishing wire, the user can pull said locating handle to make the front end of said locking pin slide out of said locking insertion hole and make said anti-rotation bulge slide out of said anti-rotation clamp slot, and then rotate said locking pin to make anti-rotation bulge misalign with said anti-rotation clamp slot. After releasing said locating handle, said locking pin locking pin locking pin will not slide front, and said supporting arm can rotate freely.

The outer rod or inner rod in the front of said fishing reel connecting base of this invention is provided with a fishing wire length counter via a quick-dismounting pipe clip. Said fishing wire length counter can count the length of fishing wire wound or rewound onto said fishing reel.

When the line spool clamping device of this invention is used, the user can operate the left line spool clamping arm and the right line spool clamping arm to make the right conical clamping head and the left conical clamping head on the left side and the right side of the central hole of the line spool clamp the line spool oppositely, when winding fishing wire onto the fishing reel, the fishing reel will pull the fishing wire to make the line spool rotate; in such a case, said right conical clamping head and left conical clamping head drive respectively the right coupling shaft and the left coupling shaft to rotate in the right clamping slide sleeve and the left clamping slide sleeve, said right conical clamping head and said left conical clamping head are relatively still, without friction, not likely to be worn and can operate more stably when contacting with the wire of the line spool. The left end face of the right clamping slide sleeve and the right side face of the right conical clamping head are load bearing faces which rotate relatively, the right end face of the left clamping slide sleeve and the left side face of the left conical clamping head are load bearing faces which rotate relatively, and load bearing faces which rotate relatively will not be likely to be worn, so their service life will be long, vibration will not happen easily, and noise is low. When the fishing wire on the fishing reel needs to be rewound onto the line spool, after the line spool is clamped and fixed according to the above instruction, the user can make the rewinding connecting rod pass through the right inserted rod through-hole, central hole of the line spool and the left inserted rod through-hole in sequence, make the left end of the rewinding connecting rod passes through the connecting shaft locknut to install the connecting shaft locknut onto the rewinding connecting rod in the way of thread connection, tighten the connecting shaft locknut which works together with the connecting shaft locating bulge loop to lock the right coupling shaft, right conical clamping head, line spool, left conical clamping head and the left coupling shaft onto the rewinding connecting rod; by rotating the rewinding crank, the line spool can be driven to rotate to rewind the fishing wire on the fishing reel onto the line spool, this device is characterized by a simple structure, convenience in use, durability, long service life, stability in use, low noise and both the winding and rewinding functions.

When using the fishing reel winding device of this invention, the user can fix the fishing reel requiring wire winding onto the expansion rod via the fishing reel connecting base, install the line spool onto the line spool clamping device, make the expansion rod extrude front and fix it, so that the wire can be wound onto the fishing reel or be rewound onto the line spool. According to setting of the expansion locating clip as well as the specification of fishing reel (dimension, structure), service site as well as the like of the user, the length of the expansion rod in service can be adjusted, so it is convenient in use and it is widely used.

### BRIEF DESCRIPTIONS OF THE DRAWINGS

FIG. 1 is a schematic diagram showing the structure of the line spool clamping device of this invention in the condition of clamping the line spool and rewinding.

FIG. 2 is a partial enlarged diagram of part A in FIG. 1.

FIG. 3 is a three-dimensional schematic diagram showing the structure of the line spool clamping device of this invention.

FIG. 4 is a three-dimensional schematic diagram showing the structure of the left hinging seat of this invention.

FIG. 5 is a three-dimensional schematic diagram showing the structure of the left clamping slide sleeve, left coupling shaft and left conical clamping head of this invention after assembly.

FIG. 6 is a three-dimensional schematic diagram showing the structure of the line spool clamping device of this invention in the condition of clamping the line spool and rewinding.

FIG. 7 is a schematic diagram showing the structure of the fishing reel winding device of this invention.

FIG. 8 is a partial enlarged diagram of part B in FIG. 7.

FIG. 9 is a partial enlarged diagram of part C in FIG. 7.

FIG. 10 is a three-dimensional schematic diagram showing the structure of the fishing reel winding device of this invention.

FIG. 11 is a three-dimensional schematic diagram showing the structure of the fishing reel winding device installed with a fishing wire length counter of this invention.

### DETAILED DESCRIPTION OF THE PREFERRED EMBODIMENTS

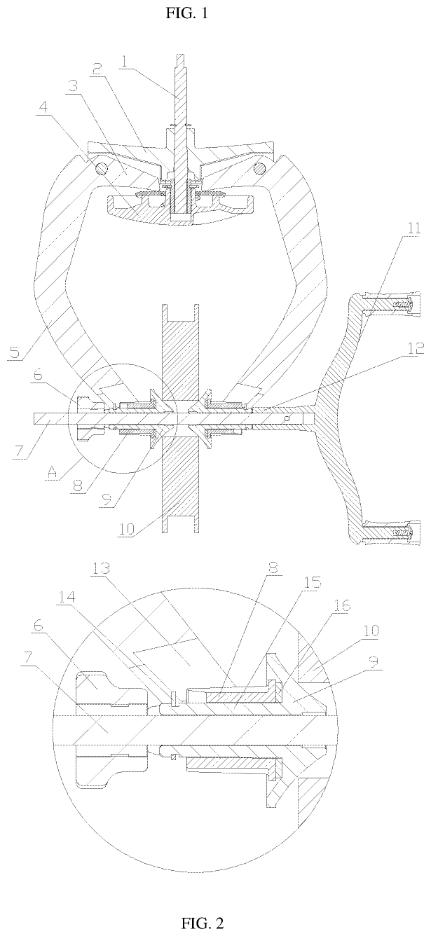

The line spool clamping device of FIG. 1-FIG. 4 comprises rotating shaft 1, supporting arm 2, left line spool clamping arm 5, right line spool clamping arm 17, power arm 3, locknut and lock disc 4, wherein, supporting arm 2 which can rotate freely is provided on rotating shaft 1, left line spool clamping arm 5 and right line spool clamping arm 17 connect respectively to one of two ends of supporting arm 2. According to FIG. 1 and FIG. 2, the lower part of supporting arm 2 is provided with a connecting slot connecting the left and the right to make the cross section of supporting arm 2 form a U-shaped opening facing downward, and the upper part of left line spool clamping arm 5 and the upper part of right line spool clamping arm 17 are respectively provided in the connecting slot on the left end and the right end of the supporting arm in the way of hinge connection. The hinged shaft connecting the left line spool clamping arm and the supporting arm is provided with power arm 3 which forms an included angle of 60-100° with the left line spool clamping arm, the hinged shaft connecting the right line spool clamping arm and the supporting arm is provided with power arm 3 which forms an included angle of 60-100° with the right line spool clamping arm, the two power arms 3 are opposite, rotating shaft 1 on the lower part of power arm 3 connects to a locknut in the way of thread connection, the locknut is provided with lock disc 4 which can press on the lower part of power arm 3, and by rotating the lock disc 4 to press power arm 3, the lower part of left line spool clamping arm 5 and right line spool clamping arm 17 can be driven to move oppositely to clamp said line spool; According to FIG. 1, the lower part of left line spool clamping arm 5 and the lower part of right line spool clamping arm 17 are in the shape of arms holding together. The above structure is the same as the existing technology. This invention is characterized in that: a left line spool clamping arm 5 and a right line spool clamping arm 17, the lower part is provided with a U-shaped left hinging seat 13 and a U-shaped right hinging seat 18, a left clamping slide sleeve is provided in the left hinging seat 13, a right clamping slide sleeve is provided in the right hinging seat 18, a left coupling shaft 15 which can rotate freely is provided in the left clamping slide sleeve 8, a right coupling shaft which can rotate freely is provided in the right clamping slide sleeve, the left end of the right coupling shaft on the left side of the right clamping slide sleeve is provided with a right conical clamping head which fits to the central hole of the line spool, the right end of the left coupling shaft 15 on the right side of the left clamping slide sleeve 8 is provided with a left conical clamping head 9 which fits to the central hole of the line spool, the left end face of the left clamping slide sleeve 8 contacts with the right side face of the right conical clamping head, and the right end face of the left clamping slide sleeve 8 contacts with the left side face of the left conical clamping head 9; The right coupling shaft on the right side of the right clamping slide sleeve is provided with a slide sleeve spacing ring, left coupling shaft 15 on the left side of left clamping slide sleeve 8 is provided with a slide sleeve spacing ring 14. According to FIG. 1 and FIG. 4, slide sleeve spacing ring 14 clamps the E-shaped snap spring inside the clamping slot on the right coupling shaft or left coupling shaft 15.

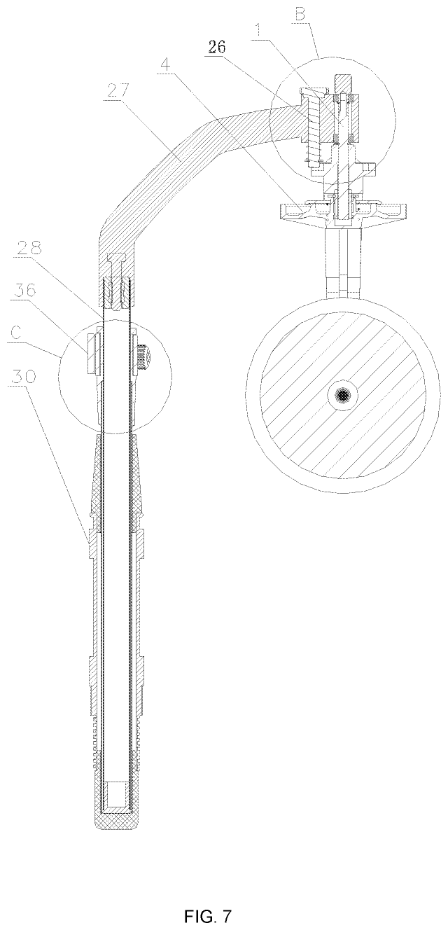

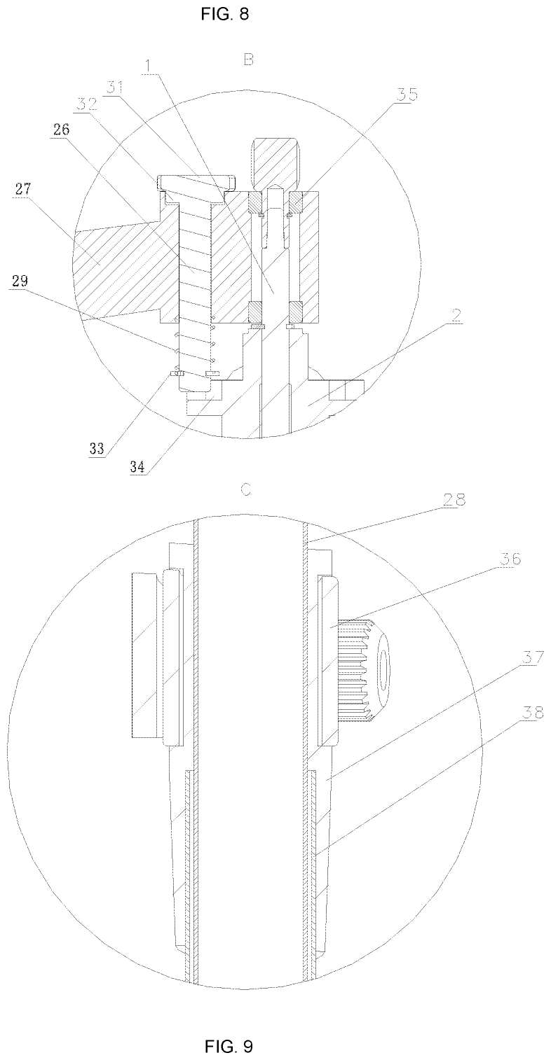

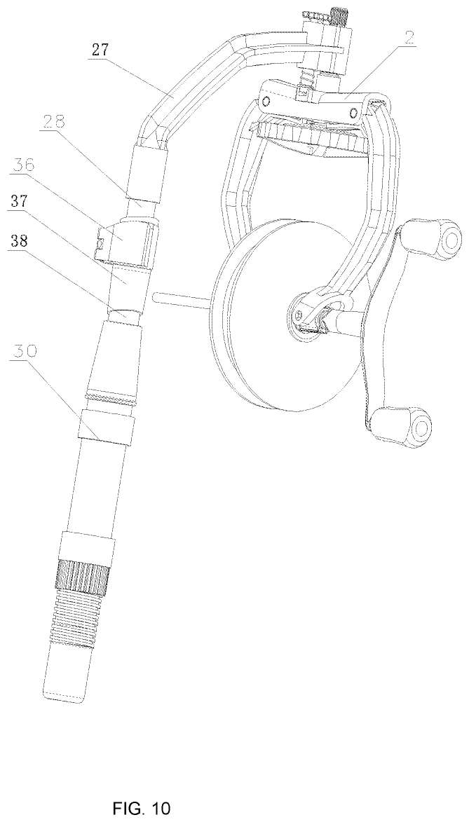

The fishing reel winding device of FIG. 7-FIG. 10 comprises a expansion rod, arc-shaped supporting arm 27 and line spool clamping device. Said expansion rod is a two-section expansion rod comprising a barrel-shaped outer rod 38 and inner rod 28, and inner rod 28 which can slide axially is inserted in outer rod 38. The front end of said outer rod 38 is provided with an expansion locating clip; Said expansion locating clip is used for locking and fixing said inner rod and outer rod as well as adjusting the extruding length of said inner rod according to the fishing reel and as needed by the user; When the fishing tackle is not used, said expansion locating clip can be used for fixing the front end of the retracted inner rod and the outer rod. According to FIG. 9, said expansion locating clip comprises connecting sleeve 37 and locking hoop 36, the rear part of connecting sleeve 37 is provided on the outer side of the front part of outer rod 38 in a fixing way, the front part of connecting sleeve 37 which can shrinkage radially is provided on the outer side of inner rod 28, and locking hoop 36 is provided on the outer side of connecting sleeve 37 outside inner rod 26. Said connecting sleeve 37 can be made of elastic materials which can shrink radially when bearing load (rubber, plastic, PE) or can be made of non-elastic materials and the side wall of its front part is provided with an axial clamping buffer slot to realize the function of radial shrinkage after bearing load; when said locking hoop 36 is locked, the front part of said connecting sleeve is pressed and fixed on the outer side of said inner rod, said locking hoop is opened, there will be no pressure between the front part of said connecting sleeve and the side wall of said inner rod, and said inner rod can slide front and back freely. The locking hoop can be a hose clamp, cam locking device, quick-dismounting pipe clip, etc. The expansion rod is provided with fishing reel connecting base 30 which connects to the outer rod in a fixing way, the front end of inner rod 28 of the expansion rod connects to the rear end of arc-shaped supporting arm 27, and the front end of arc-shaped supporting arm 27 connects to the line spool clamping device; specifically, rotating shaft 1 of the line spool clamping device which can rotate freely is installed onto the front end of arc-shaped supporting arm 27, according to the diagram, rotating shaft 1 is installed to the front end of arc-shaped supporting arm 27 via the bearing 35; said line spool clamping device comprises a rotating shaft, a supporting arm, a left line spool clamping arm, right line spool clamping arm, power arm, locknut and lock disc, the middle of said supporting arm connects to said rotating shaft, left line spool clamping arm and right line spool clamping arm respectively connect to one end of said supporting arm in the way of hinging, the hinged shaft connecting said left line spool clamping arm and said supporting arm and the hinged shaft connecting said right line spool clamping arm and supporting arm are respectively provided with an opposite power arm which forms an included angle of 60-100° with said left line spool clamping arm and said right line spool clamping arm respectively, the rotating shaft on the lower part of said power arm connects to a locknut in the way of thread connection, said locknut is provided with a lock disc which can press on the lower part of said power arm, by rotating the lock disc to press the power arm, the lower part of said left line spool clamping arm and right line spool clamping arm can be driven to move oppositely to clamp said line spool; The lower part of the left line spool clamping arm is provided with a U-shaped left hinging seat, the lower part of the right line spool clamping arm is provided with a U-shaped right hinging seat, a left clamping slide sleeve is provided in the left hinging seat, a right clamping slide sleeve is provided in the right hinging seat, a left coupling shaft which can rotate freely is provided in the left clamping slide sleeve, a right coupling shaft which can rotate freely is provided in the right clamping slide sleeve, the left end of the right coupling shaft on the left side of the right clamping slide sleeve is provided with a right conical clamping head which fits to the central hole of the line spool, the right end of the left coupling shaft on the right side of the left clamping slide sleeve is provided with a left conical clamping head which fits to the central hole of the line spool, the left end face of the left clamping slide sleeve contacts with the right side face of the right conical clamping head, and the right end face of the left clamping slide sleeve contacts with the left side face of the left conical clamping head; the right coupling shaft on the right side of the right clamping slide sleeve is provided with a slide sleeve spacing ring, and the left coupling shaft on the left side of the left clamping slide sleeve is provided with a slide sleeve spacing ring; the front end of said arc-shaped supporting arm connects to the rotating shaft of said line spool clamping device.

Based on further improvement of this invention, the front end of said arc-shaped supporting arm 27 is provided with locking slide hole parallel to rotating shaft 1, locking pin 26 which can slide freely is provided inside the locking slide hole, the front part of locking pin 26 in front of the locking slide hole is provided with baffle 33, locking pressure spring 29 is provided on locking pin 26 between baffle 33 and arc-shaped supporting arm 27, locking insertion hole 34 is provided on the part on supporting arm 2 corresponding to the locking slide hole; The rear end of said locking pin 26 on the rear side of said locking slide hole is provided with a locating handle 31, said locking pin 26 on the front side of said locating handle 31 is provided with an anti-rotation bulge 32, and said arc-shaped supporting arm 27 is provided with an anti-rotation clamp slot fitted to said anti-rotation bulge 32. During the process when said line spool is fixed on said line spool clamping device, said locking pin 26 will slide front under the action of said locking pressure spring 29, the front end of said locking pin 26 is inserted into said locking insertion hole 34, said anti-rotation bulge 32 on the rear part of said locking pin slides into said anti-rotation clamp slot to lock said supporting arm 2 and prevent rotation of said supporting arm, so that said line spool is installed conveniently. When winding the fishing wire, the user can pull said locating handle to make the front end of said locking pin slide out of said locking insertion hole and make said anti-rotation bulge slide out of said anti-rotation clamp slot, and then rotate said locking pin to make anti-rotation bulge misalign with said anti-rotation clamp slot. After releasing said locating handle, said locking pin locking pin locking pin will not slide front, and said supporting arm can rotate freely.

Based on further improvement of this invention, the middle of said left conical clamping head 9 and said left coupling shaft 15 are provided with a coaxial left inserted rod through-hole, and the middle of said right conical clamping head and said right coupling shaft is provided with a coaxial right inserted rod through-hole; according to FIG. 1, the left conical clamping head and left coupling shaft are integral, and right conical clamping head and right coupling shaft are integral.

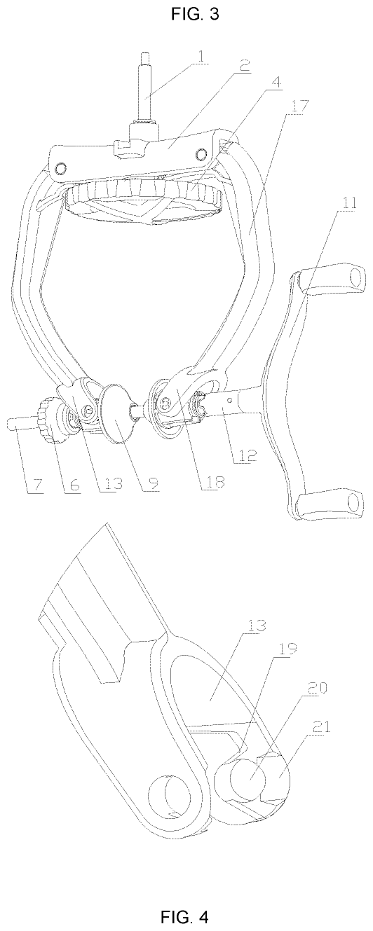

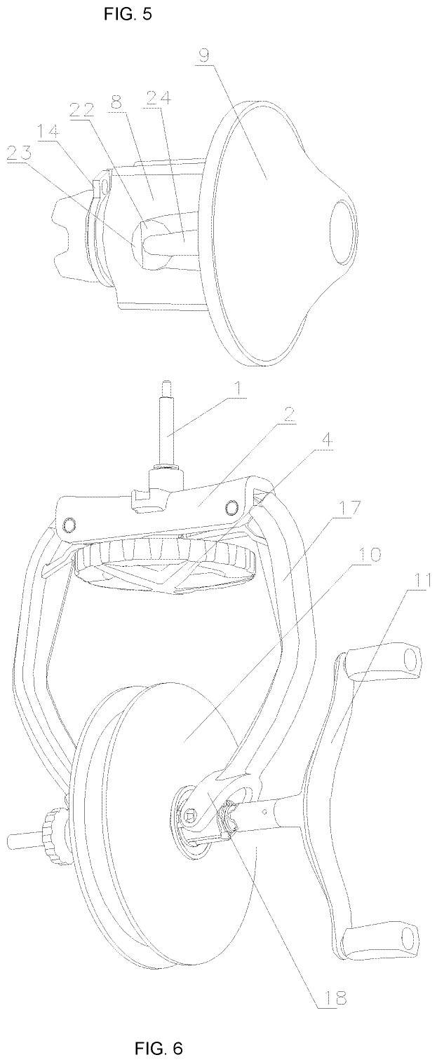

Rewinding connecting rod 7 which is provided in the left inserted rod through-hole and the right inserted rod through-hole at the same time is provided, the right end of rewinding connecting rod is provided with rewinding crank 11, rewinding connecting rod 7 on the left side of rewinding crank 11 is provided with connecting shaft locating bulge loop 12 which fits to the right end face of the right coupling shaft, according to FIG. 1 and FIG. 3, the connecting shaft locating bulge loop is in a sleeve shape and is integrated with the rewinding crank and connects to the right end of the rewinding crank in a muff-coupling way; the right end face of the right coupling shaft meshes with the left end face of connecting shaft locating bulge loop 12, enabling stable connection. The rewinding connecting rod on the left side of left coupling shaft 15 is provided in the way of thread connection with connecting shaft locknut 6 which fits to the left end face of left coupling shaft 15. According to FIG. 3 and FIG. 5, the left end face of left coupling shaft 15 meshes with the right end face of connecting shaft locknut 6, enabling stable connection.

Based on further improvement of this invention, a smooth wear-resistant gasket is provided with the left end face of said right clamping slide sleeve and the right side face of said right conical clamping head, and a smooth wear-resistant gasket 16 is provided between the right side face of said left clamping slide sleeve 8 and the left side face of said left conical clamping head 9. Said smooth wear-resistant gasket 16 can be a smooth metal gasket, graphite gasket, etc.; such a gasket can reduce friction and cannot be worn easily, and its service life can be prolonged.

Based on further improvement of this invention, the structure which is provided with said left clamping slide sleeve 8 and said right clamping slide sleeve in the way of hinge respectively in said left hinging seat 13 and said right hinging seat 18 is: The lower part of two hinging arms of said left hinging seat 13 are provided with hinging holes 20 respectively, the right side of hinging holes 20 inside two hinging arms (opposite side) is provided with an outward tilted left hinging guide slide slot 21 from the left to the right respectively, both sides of said left clamping slide sleeve 8 are provided with a left hinging column fitted to two hinging holes 20 on said left hinging seat 13, the left side of two left hinging columns 22 (end face) is respectively provided with a guide slide face 23 which is outward tilted from the left to the right and is fitted to two left hinging guide slide slots 21; The lower part of two hinging arms of said right hinging seat are provided with hinging holes respectively, the left side of hinging holes inside two hinging arms (opposite side) is provided with an outward tilted right hinging guide slide slot from the right to the left respectively, both sides of said right clamping slide sleeve are provided with a right hinging column fitted to two hinging holes on said right hinging seat, the right side of two right hinging columns (end face) is respectively provided with a guide slide face which is outward tilted from the right to the left and is fitted to two right hinging guide slide slots. When said left clamping slide sleeve connects to said left hinging seat and when said right clamping slide sleeve connects to right hinging seat, the user only needs to press the guide slide face 23 of said left hinging column 22 and said right hinging column into the two hinging arms of the left hinging seat and the right hinging seat by aligning the guide slide face of said left hinging column and said right hinging column with the fitted left hinging guide slide slot 21 and hinging guide slide slot respectively to open it, two left hinging columns 22 slide into two hinging holes 20 on the left hinging seat, two right hinging columns slide into two hinging holes on the right hinging base, to finish installation of hinged fitting. The hinging structure is simple and can be installed conveniently without using connecting components, such as screw, pin column, etc., reducing costs.

Based on further improvement of this invention, the inner side of two hinging arms of said left hinging seat 13 and the upper side and lower side of the left hinging guide slide slot 21 on the right side of hinging hole 20 are provided respectively with swinging limit block 19, left clamping slide sleeve 8 on the right side of left hinging column 22 is provided with limit barrier strip 24 which fits to swinging limit block 19, and limit barrier strip 24 can swing between two swinging limit blocks 19 to limit that left clamping slide sleeve 8 swings up and down within the horizontal included angle no more than 35°; according to FIG. 4 and FIG. 5, said swinging limit blocks include the upper swing limit block and the lower swinging limit block which are tangent to hinging holes respectively, are provided with the included angle of 65° and extend to the right. The inner side of two hinging arms of said right hinging seat as well as the upper side and the lower side of said right hinging guide slide slot on the left side of said hinging holes are respectively provided with a swinging limit block, said right clamping slide sleeve on the left side of said right hinging column is provided with a limit barrier strip fitted to said swinging limit block, said limit barrier strip swings between two swinging limit blocks to limit that said right clamping slide sleeve swings up and down within the scope of a horizontal included angle of 35°; The said swinging limit blocks include the upper swing limit block and the lower swinging limit block which are tangent to hinging holes respectively, are provided with the included angle of 65° and extend to the left. During the process when the left conical clamping head and right conical clamping head clamp respectively the left side and the right side of the central hole of the line spool, the left conical clamping head and right conical clamping head can swing up and down to realize floating-type locating, the centerline of said left conical clamping head and said right conical clamping head coincides with the centerline of the line spool, and winding and rewinding will be more stable. When the setting of the swinging limit block and the limit barrier strip does not make the left conical clamping head and the right conical clamping head clamp the central hole of the line spool, their drop angle is small, so that the left conical clamping head and the right conical clamping head align with the central hole of the line spool easily when the line spool is installed between the left line spool clamping arm and the right line spool clamping arm.

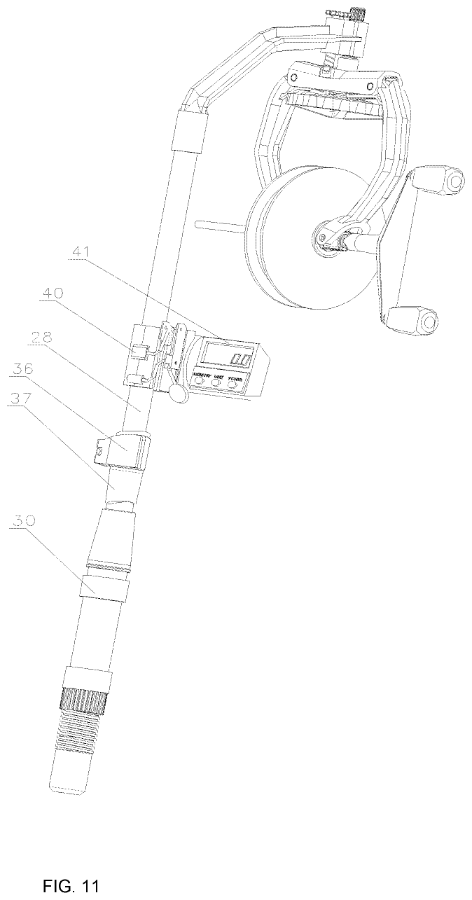

Based on further improvement of this invention, the outer rod or inner rod in the front of fishing reel connecting base is provided with a fishing wire length counter via a quick-dismounting pipe clip. Said fishing wire length counter can count the length of fishing wire wound or rewound onto said fishing reel. According to FIG. 11, fishing wire length counter 41 is fixed through clamping to inner rod 28 via quick-dismounting pipe clip 40, after the wire is wound onto fishing reel and the inner rod needs to retract back into the outer rod, the quick-dismounting pipe clip 40 should be opened to disassemble fishing wire length counter 41 and quick-dismounting pipe clip 40 from the inner rod, and then the inner rod is made retract back into the outer rod. The fishing wire length counter is the existing mechanical fishing wire length counter or electronic fishing wire length counter.

When the line spool clamping device of this invention is used, the user can operate the left line spool clamping arm and the right line spool clamping arm to make the right conical clamping head and the left conical clamping head on the left side and the right side of the central hole of the line spool clamp the line spool oppositely, when winding fishing wire onto the fishing reel, the fishing reel will pull the fishing wire to make the line spool rotate; in such a case, said right conical clamping head and left conical clamping head drive respectively the right coupling shaft and the left coupling shaft to rotate in the right clamping slide sleeve and the left clamping slide sleeve, said right conical clamping head and said left conical clamping head are relatively still, without friction, not likely to be worn and can operate more stably when contacting with the wire of the line spool. The left end face of the right clamping slide sleeve and the right side face of the right conical clamping head are load bearing faces which rotate relatively, the right end face of the left clamping slide sleeve and the left side face of the left conical clamping head are load bearing faces which rotate relatively, and load bearing faces which rotate relatively will not be likely to be worn, so their service life will be long, vibration will not happen easily, and noise is low. When the fishing wire on the fishing reel needs to be rewound onto the line spool, after the line spool is clamped and fixed according to the above instruction, the user can make the rewinding connecting rod pass through the right inserted rod through-hole, central hole of the line spool and the left inserted rod through-hole in sequence, make the left end of the rewinding connecting rod passes through the connecting shaft locknut to install the connecting shaft locknut onto the rewinding connecting rod in the way of thread connection, tighten the connecting shaft locknut which works together with the connecting shaft locating bulge loop to lock the right coupling shaft, right conical clamping head, line spool, left conical clamping head and the left coupling shaft onto the rewinding connecting rod; by rotating the rewinding crank, the line spool can be driven to rotate to rewind the fishing wire on the fishing reel onto the line spool, this device is characterized by a simple structure, convenience in use, durability, long service life, stability in use, low noise and both the winding and rewinding functions.

When using the fishing reel winding device of this invention, the user can fix the fishing reel requiring wire winding onto the expansion rod via the fishing reel connecting base, install the line spool onto the line spool clamping device, make the expansion rod extrude front and fix it, so that the wire can be wound onto the fishing reel or be rewound onto the line spool. According to setting of the expansion locating clip as well as the specification of fishing reel (dimension, structure), service site as well as the like of the user, the length of the expansion rod in service can be adjusted, so it is convenient in use and it is widely used.

What is claimed is:

1. A line spool clamping device, comprising a left clamping arm and a right clamping arm, characterized in that the lower part of the left clamping arm is provided with a U-shaped left hinging seat, the lower part of the right clamping arm is provided with a U-shaped right hinging seat, a left clamping slide sleeve is provided in the left hinging seat, a right clamping slide sleeve is provided in the right hinging seat, a left coupling shaft which can rotate freely is provided in the left clamping slide sleeve, a right coupling shaft which can rotate freely is provided in the right clamping slide sleeve, the left end of the right coupling shaft on the left side of the right clamping slide sleeve is provided with a right conical clamping head which fits to the central hole of the line spool, the right end of the left coupling shaft on the right side of the left clamping slide sleeve is provided with a left conical clamping head which fits to the central hole of the line spool, the left end face of the left clamping slide sleeve contacts with the right side face of the right conical clamping head, and the right end face of the left clamping slide sleeve contacts with the left side face of the left conical clamping head; the right coupling shaft on the right side of the right clamping slide sleeve is provided with a slide sleeve spacing ring, and the left coupling shaft on the left side of the left clamping slide sleeve is provided with a slide sleeve spacing ring.

2. The line spool clamping device of claim 1, characterized in that the middle of said left conical clamping head and left coupling shaft is provided with a left inserted rod through-hole, and the middle of said right conical clamping head and right coupling shaft is provided with a right inserted rod through-hole; a rewinding connecting rod which can be inserted in the left inserted rod through-hole and the right inserted rod through-hole at the same time is provided, the right end of the rewinding connecting rod is provided with a rewinding crank, the rewinding connecting rod on the left side of the rewinding crank is provided with a connecting shaft locating bulge loop, the rewinding connecting rod on the left side of the left coupling shaft is provided with a connecting shaft locknut in the way of thread connection.

3. The line spool clamping device of claim 1, characterized in that a smooth wear-resistant gasket is provided between the left end face of said right clamping slide sleeve and the right side face of said right conical clamping head, and a smooth wear-resistant gasket is provided between the right end face of said left clamping slide sleeve and the left side face of said left conical clamping head.

4. The line spool clamping device of claim 3, characterized in that, the structure which is provided with said left clamping slide sleeve and said right clamping slide sleeve in the way of hinge respectively in said left hinging seat and said right hinging seat is: The lower part of two hinging arms of said left hinging seat are provided with hinging holes respectively, the right side of hinging holes inside two hinging arms is provided with an outward tilted left hinging guide slide slot from the left to the right respectively, both sides of said left clamping slide sleeve are provided with a left hinging column fitted to two hinging holes on said left hinging seat, the left side of two left hinging columns is respectively provided with a guide slide face which is outward tilted from the left to the right and is fitted to two left hinging guide slide slots; The lower part of two hinging arms of said right hinging seat are provided with hinging holes respectively, the left side of hinging holes inside two hinging arms is provided with an outward tilted right hinging guide slide slot from the right to the left respectively, both sides of said right clamping slide sleeve are provided with a right hinging column fitted to two hinging holes on said right hinging seat, the right side of two right hinging columns is respectively provided with a guide slide face which is outward tilted from the right to the left and is fitted to two right hinging guide slide slots.

5. The line spool clamping device of claim 4, characterized in that the inner side of two hinging arms of said left hinging seat as well as the upper side and the lower side of said left hinging guide slide slot on the right side of said hinging holes are respectively provided with a swinging limit block, said left clamping slide sleeve on the right side of said left hinging column is provided with a limit barrier strip fitted to said swinging limit block, said limit barrier strip swings between two swinging limit blocks to limit that said left clamping slide sleeve swings up and down within the scope of a horizontal included angle of 35°; The inner side of two hinging arms of said right hinging seat as well as the upper side and the lower side of said right hinging guide slide slot on the left side of said hinging holes are respectively provided with a swinging limit block, said right clamping slide sleeve on the left side of said right hinging column is provided with a limit barrier strip fitted to said swinging limit block, said limit barrier strip swings between two swinging limit blocks to limit that said right clamping slide sleeve swings up and down within the scope of a horizontal included angle of 35°.

6. A fishing reel winding device, characterized in comprising an expansion rod, an arc-shaped supporting arm and a line spool clamping device, wherein, said expansion rod is provided with a fishing reel connecting base, the front end of said expansion rod connects to the rear end of said arc-shaped supporting arm, and the front end of said arc-shaped supporting arm connects to said line spool clamping device; said line spool clamping device comprises a rotating shaft, a supporting arm, a left line spool clamping arm, right line spool clamping arm, power arm, locknut and lock disc, said rotating shaft which can rotate freely is installed on the front end of said arc-shaped supporting arm, the middle of said supporting arm connects to said rotating shaft, left line spool clamping arm and right line spool clamping arm respectively connect to one end of said supporting arm in the way of hinging, the hinged shaft connecting said left line spool clamping arm and said supporting arm and the hinged shaft connecting said right line spool clamping arm and supporting arm are respectively provided with an opposite power arm which forms an included angle of 60-100° with said left line spool clamping arm and said right line spool clamping arm respectively, the rotating shaft on the lower part of said power arm connects to a locknut in the way of thread connection, said locknut is provided with a lock disc which can press on the lower part of said power arm, by rotating the lock disc to press the power arm, the lower part of said left line spool clamping arm and right line spool clamping arm can be driven to move oppositely to clamp said line spool; The lower part of the left line spool clamping arm is provided with a U-shaped left hinging seat, the lower part of the right line spool clamping arm is provided with a U-shaped right hinging seat, a left clamping slide sleeve is provided in the left hinging seat, a right clamping slide sleeve is provided in the right hinging seat, a left coupling shaft which can rotate freely is provided in the left clamping slide sleeve, a right coupling shaft which can rotate freely is provided in the right clamping slide sleeve, the left end of the right coupling shaft on the left side of the right clamping slide sleeve is provided with a right conical clamping head which fits to the central hole of the line spool, the right end of the left coupling shaft on the right side of the left clamping slide sleeve is provided with a left conical clamping head which fits to the central hole of the line spool, the left end face of the left clamping slide sleeve contacts with the right side face of the right conical clamping head, and the right end face of the left clamping slide sleeve contacts with the left side face of the left conical clamping head; the right coupling shaft on the right side of the right clamping slide sleeve is provided with a slide sleeve spacing ring, and the left coupling shaft on the left side of the left clamping slide sleeve is provided with a slide sleeve spacing ring; the front end of said arc-shaped supporting arm connects to the rotating shaft of said line spool clamping device.

7. The fishing reel winding device of claim 6, characterized in that said expansion rod is a two-section expansion rod comprising a barrel-shaped outer rod and an inner rod, said inner rod can be inserted into said outer rod in the way of axial sliding, said fishing reel connecting base is provided on said outer rod; The front end of said outer rod is provided with an expansion locating clip.

8. The fishing reel winding device of claim 7, characterized in that said expansion locating clip comprises a connecting sleeve and a locking hoop, the rear part of said connecting sleeve is fixed on the outer side on the front end of said outer rod, the front part of said connecting sleeve is provided on the outer side of said inner rod in the way of radial shrinkage, and the locking loop is provided outside the connecting sleeve which is on the outer side of said inner rod; the outer rod or inner rod in the front of said fishing reel connecting base is provided with a fishing wire length counter via a quick-dismounting pipe clip.

9. The fishing reel winding device of claim 8, characterized in that said arc-shaped supporting arm is provided with a locking slide hole parallel to said rotating shaft, a locking pin which can slide freely is provided in said locking slide hole, the front of said locking pin in front of said locking slide hole is provided with a baffle, the locking pin between said baffle and said arc-shaped supporting arm is provided with a locking pressure spring, and the part on said supporting arm and corresponding to said locking slide hole is provided with a locking insertion hole. The rear end of said locking pin on the rear side of said locking slide hole is provided with a locating handle, said locking pin on the front side of said locating handle is provided with an anti-rotation bulge, and said arc-shaped supporting arm is provided with an anti-rotation clamp slot fitted to said anti-rotation bulge.

10. The line spool clamping device of claim 6, characterized in that the middle of said left conical clamping head and left coupling shaft is provided with a left inserted rod through-hole, and the middle of said right conical clamping head and right coupling shaft is provided with a right inserted rod through-hole; a rewinding connecting rod which can be inserted in the left inserted rod through-hole and the right inserted rod through-hole at the same time is provided, the right end of the rewinding connecting rod is provided with a rewinding crank, the rewinding connecting rod on the left side of the rewinding crank is provided with a connecting shaft locating bulge loop, the rewinding connecting rod on the left side of the left coupling shaft is provided with a connecting shaft locknut in the way of thread connection; a smooth wear-resistant gasket is provided with the left end face of said right clamping slide sleeve and the right side face of said right conical clamping head, and a smooth wear-resistant gasket is provided between the right side face of said left clamping slide sleeve and the left side face of said left conical clamping head; the structure which is provided with said left clamping slide sleeve and said right clamping slide sleeve in the way of hinge respectively in said left hinging seat and said right hinging seat is: The lower part of two hinging arms of said left hinging seat are provided with hinging holes respectively, the right side of hinging holes inside two hinging arms is provided with an outward tilted left hinging guide slide slot from the left to the right respectively, both sides of said left clamping slide sleeve are provided with a left hinging column fitted to two hinging holes on said left hinging seat, the left side of two left hinging columns is respectively provided with a guide slide face which is outward tilted from the left to the right and is fitted to two left hinging guide slide slots; The lower part of two hinging arms of said right hinging seat are provided with hinging holes respectively, the left side of hinging holes inside two hinging arms is provided with an outward tilted right hinging guide slide slot from the right to the left respectively, both sides of said right clamping slide sleeve are provided with a right hinging column fitted to two hinging holes on said right hinging seat, the right side of two right hinging columns is respectively provided with a guide slide face which is outward tilted from the right to the left and is fitted to two right hinging guide slide slots. The inner side of two hinging arms of said left hinging seat as well as the upper side and the lower side of said left hinging guide slide slot on the right side of said hinging holes are respectively provided with a swinging limit block, said left clamping slide sleeve on the right side of said left hinging column is provided with a limit barrier strip fitted to said swinging limit block, said limit barrier strip swings between two swinging limit blocks to limit that said left clamping slide sleeve swings up and down within the scope of a horizontal included angle of 35°; The inner side of two hinging arms of said right hinging seat as well as the upper side and the lower side of said right hinging guide slide slot on the left side of said hinging holes are respectively provided with a swinging limit block, said right clamping slide sleeve on the left side of said right hinging column is provided with a limit barrier strip fitted to said swinging limit block, said limit barrier strip swings between two swinging limit blocks to limit that said right clamping slide sleeve swings up and down within the scope of a horizontal included angle of 35°.
